(19) United States
(12) Patent Application Publication
(10) Pub. No.: US 2024/0214943 A1
(43) Pub. Date: Jun. 27, 2024

(54) UL POWER CONTROL IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 18/530,058

(22) Filed: Dec. 5, 2023

Related U.S. Application Data
(60) Provisional application No. 63/434,685, filed on Dec. 22, 2022.

(51) Int. Cl. H04W 52/14; H04W 52/24; H04W 72/1268; H04W 72/232

(52) U.S. Cl. CPC H04W 52/146; H04W 52/242; H04W 72/1268; H04W 72/232

(57) ABSTRACT

Apparatuses and methods for uplink (UL) power control in full-duplex (FD) systems. A method of operating a user equipment (UE) includes receiving first and second information for first and second sets of power control parameters for first and second UL channels or signals associated with first and second subset of slots, respectively, from a set of slots on a cell; determining, based on a slot for a transmission being from the second subset of slots, a first power control value from the second set of power control parameters for the transmission; and transmitting, based on the first power control value, the second UL channel or signal in the slot. The second subset of slots include time-domain resources indicated for simultaneous transmission and reception on the cell and the first subset does not.

### CROSS-REFERENCE TO RELATED AND CLAIM OF PRIORITY

The present application claims priority under 35 U.S.C. § 119(e) to: U.S. Provisional Patent Application No. 63/434,685 filed on Dec. 22, 2022, which is hereby incorporated by reference in its entirety.

### TECHNICAL FIELD

The present disclosure relates generally to wireless communication systems and, more specifically, the present disclosure is related to apparatuses and methods for uplink (UL) power control in full-duplex (FD) systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL power control in FD systems.

In one embodiment, a method of operating a user equipment (UE) for transmitting an UL channel or signal is provided. The method includes receiving first information for a first set of power control parameters for a first UL channel or signal associated with a first subset of slots from a set of slots on a cell and receiving second information for a second set of power control parameters for a second UL channel or signal associated with a second subset of slots from the set of slots on the cell. The method further includes determining, based on a slot for a transmission being from the second subset of slots, a first power control value from the second set of power control parameters for the transmission and transmitting, based on the first power control value, the second UL channel or signal in the slot. The first subset of slots do not include time-domain resources indicated for simultaneous transmission and reception on the cell. The second subset of slots include time-domain resources indicated for simultaneous transmission and reception on the cell.

In another embodiment, a UE is provided. The UE includes a transceiver configured to receive first information for a first set of power control parameters for a first UL channel or signal associated with a first subset of slots from a set of slots on a cell and receive second information for a second set of power control parameters for a second UL channel or signal associated with a second subset of slots from the set of slots on the cell. The UE further includes a processor operably coupled with the transceiver, the processor configured to determine, based on a slot for a transmission being from the second subset of slots, a first power control value from the second set of power control parameters for the transmission. The transceiver is further configured to transmit, based on the first power control value, the second UL channel or signal in the slot. The first subset of slots do not include time-domain resources indicated for simultaneous transmission and reception on the cell. The second subset of slots include time-domain resources indicated for simultaneous transmission and reception on the cell.

In yet another embodiment, a base station (BS) is provided. The BS includes a transceiver configured to transmit first information for a first set of power control parameters for a first UL channel or signal associated with a first subset of slots from a set of slots on a cell; transmit second information for a second set of power control parameters for a second UL channel or signal associated with a second subset of slots from the set of slots on the cell; and receive the second UL channel or signal in a slot from the second subset of slots, the second UL channel or signal associated with a first power control value from the second set of power control parameters. The first subset of slots do not include time-domain resources indicated for simultaneous transmission and reception on the cell. The second subset of slots include time-domain resources indicated for simultaneous transmission and reception on the cell.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a timeline of an example time division duplex (TDD) configuration according to embodiments of the present disclosure;

FIG. 7 illustrates timelines of example FD configurations according to embodiments of the present disclosure;

FIG. 8 illustrates a timeline for physical uplink control channel (PUSCH) transmission(s) according to embodiments of the present disclosure;

FIG. 9 illustrates a flowchart of an example UE procedure for PUSCH transmission(s) according to embodiments of the present disclosure;

FIG. 10 illustrates a timeline for configured grant PUSCH transmission(s) according to embodiments of the present disclosure;

FIG. 11 illustrates a flowchart of an example UE procedure for configured grant PUSCH transmission(s) according to embodiments of the present disclosure;

FIG. 12 illustrates a timeline for PUSCH transmission(s) according to embodiments of the present disclosure; and

FIG. 13 illustrates a flowchart of an example UE procedure for PUSCH transmission(s) according to embodiments of the present disclosure.

### DETAILED DESCRIPTION

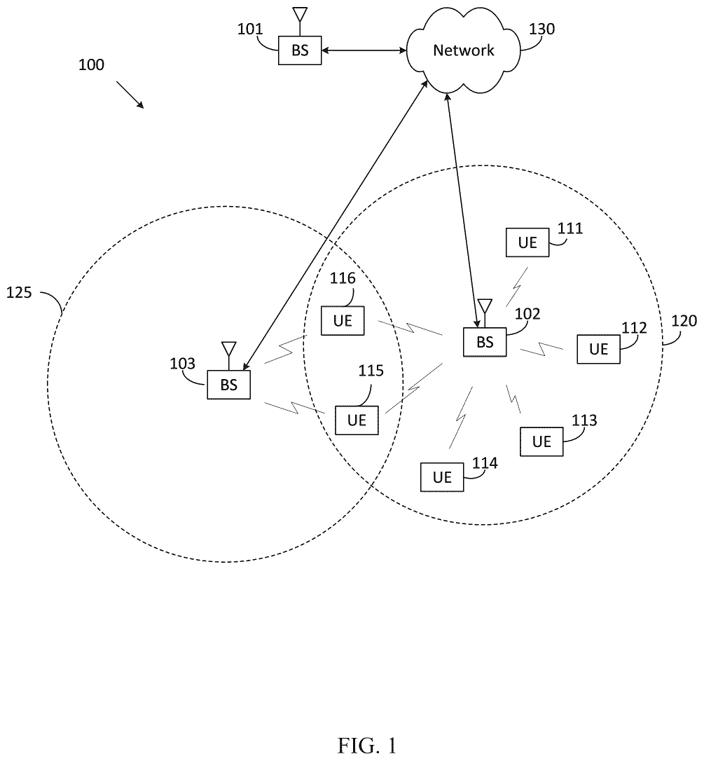

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein.: 3GPP TS 38.211 v17.2.0, “NR; Physical channels and modulation” (REF1); 3GPP TS 38.212 v17.2.0, “NR; Multiplexing and Channel coding” (REF2); 3GPP TS 38.213 v17.2.0, “NR; Physical Layer Procedures for Control” (REF3); 3GPP TS 38.214 v17.2.0, “NR; Physical Layer Procedures for Data” (REF4); 3GPP TS 38.321 v17.1.0, “NR; Medium Access Control (MAC) protocol specification” (REF5); 3GPP TS 38.331 v17.1.0, “NR; Radio Resource Control (RRC) Protocol Specification” (REF6); 3GPP TS 38.306 v17.1.0, “NR; User Equipment (UE) radio access capabilities” (REF7); and 3GPP TS 38.133 v17.2.0, “NR; Requirements for support of radio resource management” (REF8).

FIGS. 1-14 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to identify and transmit according to UL power controls in FD systems. In certain embodiments, one or more of the BSs 101-103 include circuitry, programing, or a combination thereof to support UL power control in FD systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

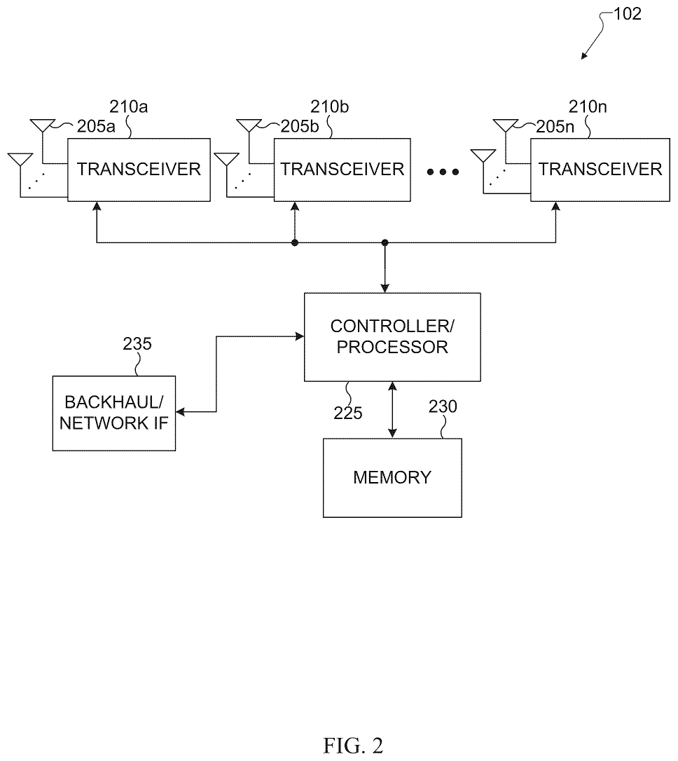

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods to support UL power control in FD systems as described in greater detail below. Any of a wide variety of other functions could be supported in the gNB 102 by the controller/processor 225. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

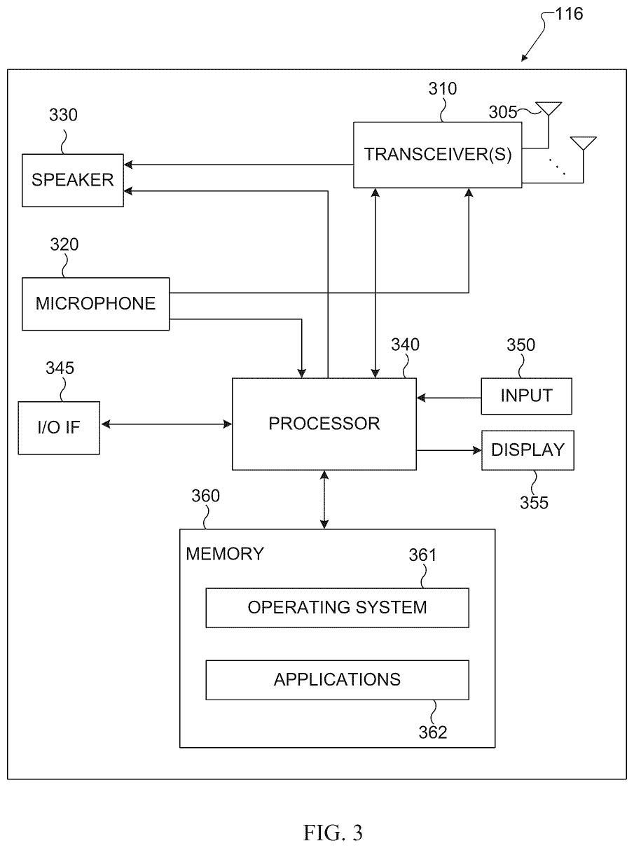

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute identify and transmit according to UL power controls in FD systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

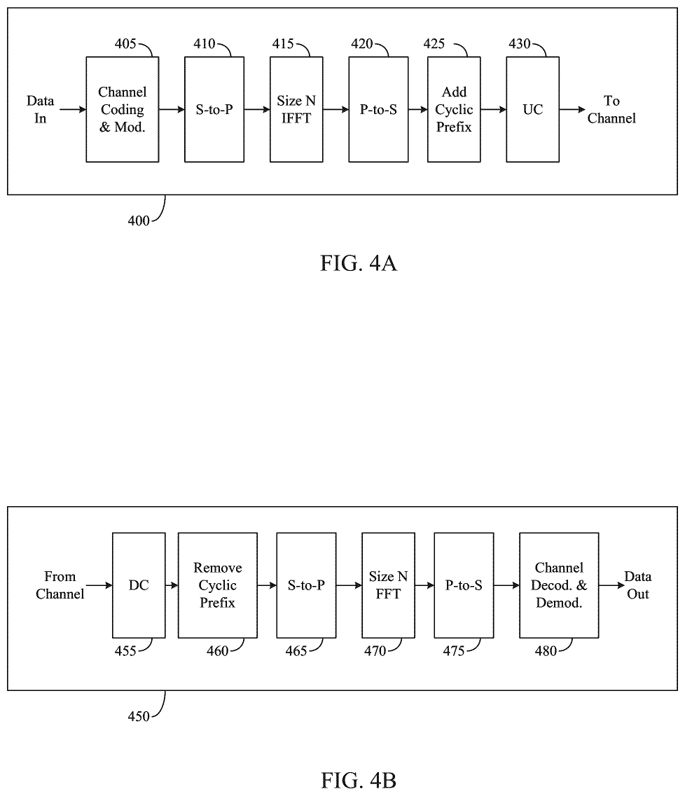

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to receive information for parameters for UL power control in FD systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}).

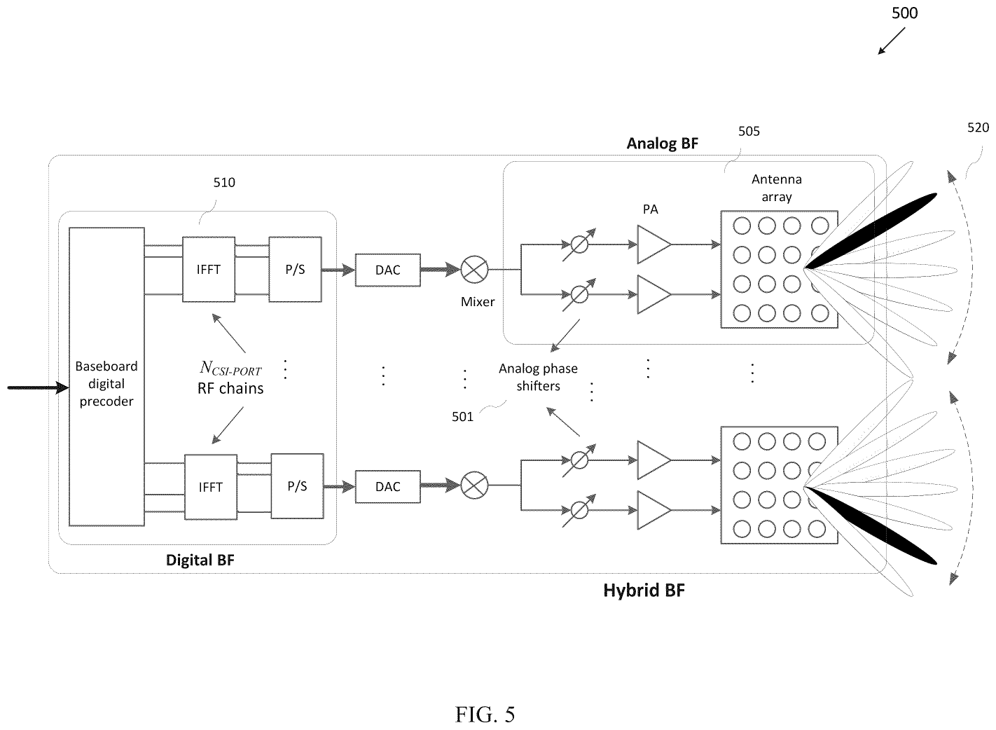

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 2-2 or FR2-2). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

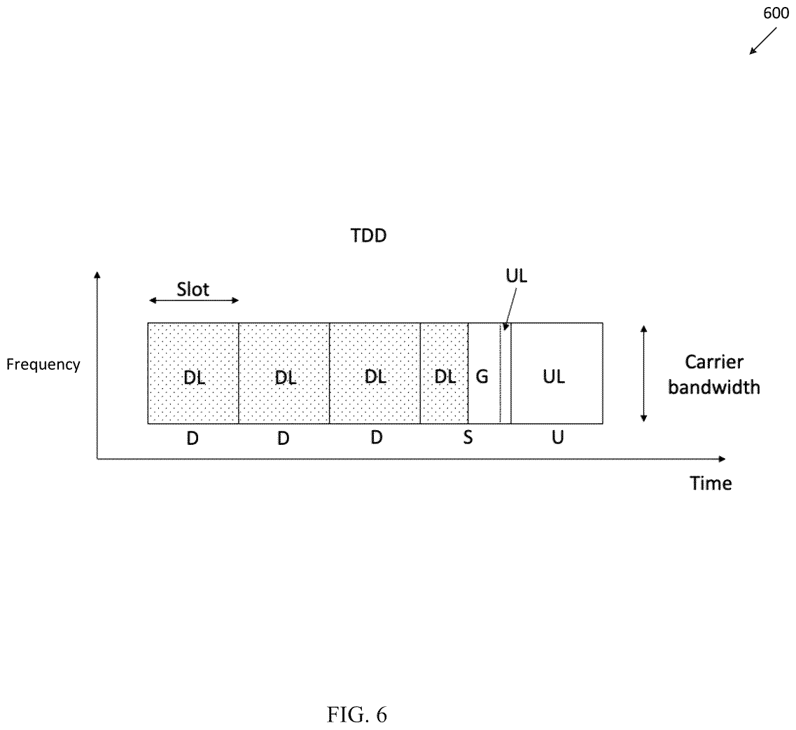

FIG. 6 illustrates a timeline 600 of an example TDD configuration. For example, timeline 600 of an example TDD configuration can be utilized by the BS 102 of FIG. 1 and the UE 116 of FIG. 3. This example is for illustration only and other embodiments can be used without departing from the scope of the present disclosure.

With reference to FIG. 6, A DDDSU UL-DL configuration is shown Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL evaluating an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a physical uplink control channel (PUCCH) providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a downlink control information (DCI) format is supported. With the exception of some symbols in some slots supporting predetermined transmissions, such as for SSBs, symbols of a slot or in a subband can have a flexible direction (UL or DL) that a UE can determine according to scheduling information for transmissions or receptions. A physical downlink control channel (PDCCH) can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross link interference (CLI) where, for example, DL receptions in a cell by a UE can experience large interference from UL transmissions in the same or neighboring cells from other UEs.

FD communications offer a potential for increased spectral efficiency, improved capacity, and reduced latency in wireless networks. When using FD communications, a gNB or a UE simultaneously receives and transmits on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE 116 occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present disclosure recognize full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the present disclosure, the term Full-Duplex (FD) is used as a short form for a full-duplex operation in a wireless system. The terms Cross-Division-Duplex (XDD) and FD may be used interchangeably in the present disclosure.

FD operation in NR can improve spectral efficiency, link robustness, capacity, and latency of UL transmissions. In an NR TDD system, transmissions from a UE are limited by fewer available transmission opportunities than receptions by the UE 116. For example, for NR TDD with subcarrier spacing (SCS)=30 kHz, DDDU (2 msec), DDDSU (2.5 msec), or DDDDDDDSUU (5 msec), the UL-DL configurations allow for an DL:UL ratio from 3:1 to 4:1. Any transmission from the UE 116 can only occur in a limited number of UL slots, for example every 2, 2.5, or 5 msec, respectively.

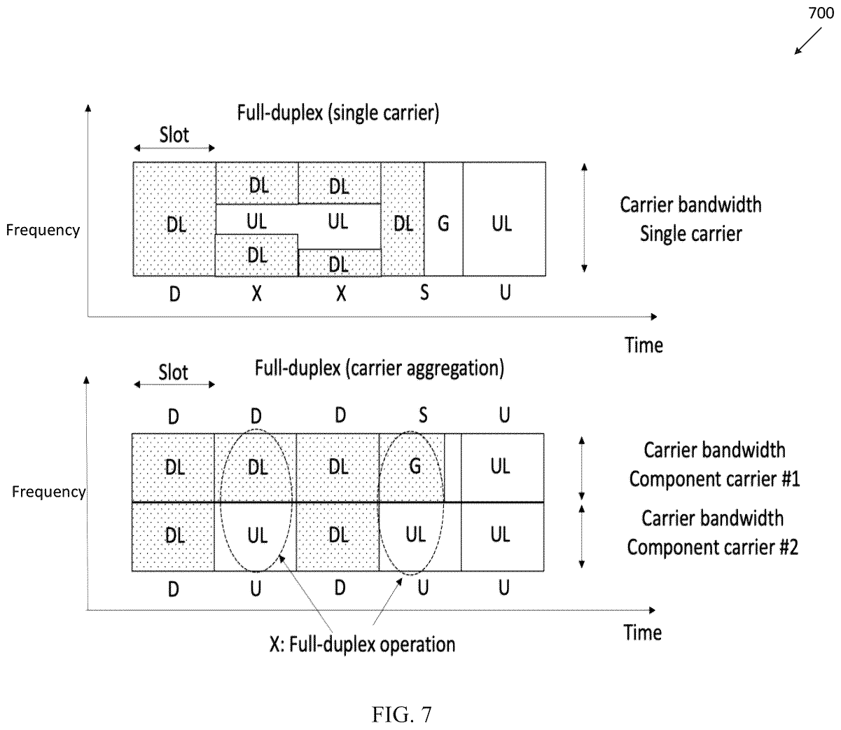

FIG. 7 illustrates timelines 700 of example FD configurations according to embodiments of the present disclosure. For example, timelines 700 can be utilized by the BS 102 of FIG. 1 and the UE 116 of FIG. 3. This example is for illustration only and other embodiments can be used without departing from the scope of the present disclosure.

For a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB 102/UE 116, and S slots that are used for both transmission and receptions by the gNB 102/UE 116 and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

In the following, unless otherwise explicitly noted, providing a parameter value by higher layers includes providing the parameter value by a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF3.

In the following, for brevity of description, the term ‘fd-config’ is used to describe the configuration and parameterization for UE determination of receptions and/or transmissions in a serving cell supporting full-duplex operation. For example, the UE may be provided with the set of RBs or set of symbols of an SBFD UL or DL subband. It is not necessary that the use of full-duplex operation by a gNB in the serving cell when scheduling to a UE receptions and/or transmissions in a slot or symbol is identifiable by or known to the UE. For example, parameters associated with the parameter ‘fd-config’ may include a set of time-domain resources, e.g., symbols/slots, where receptions or transmissions by the UE are allowed, possible, or disallowed; a range or a set of frequency-domain resources, e.g., serving cells, BWPs, start and/or end or a set of RBs, where receptions or transmissions by the UE are allowed, possible, or disallowed; one or multiple guard intervals for time and/or frequency domain radio resources during receptions or transmissions by the UE, e.g., guard SCs or RBs, guard symbols; one or multiple resource types, e.g., ‘simultaneous Tx-Rx’, ‘Rx only’, or ‘Tx only’ or ‘D’, ‘U’, ‘F’, ‘N/A’; one or multiple scheduling behaviors, e.g., “DG only”, “CG only”, “any”. Configuration and/or parameters associated with the fd-config may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE. Configuration and/or parameters associated with the fd-config may be provided to the UE using higher layer signaling, DCI-based signaling, and/or MAC CE based signaling. For example, configuration and/or parameters associated with fd-config may be provided to the UE by means of common RRC signaling using SIB or by UE-dedicated RRC signaling such as ServingCellConfig. For example, configuration and/or parameters associated with fd-config may be provided to the UE using an RRC-configured TDRA table, or a PDCCH, PDSCH, PUCCH or PUSCH configuration, and/or DCI-based signaling that indicates to the UE a configuration for the UE to apply.

Using the NR UL transmit power control procedure, a UE determines transmission power value(s) for a variety of transmissions including, but not limited to, PUSCH, PUCCH, sounding reference signal (SRS), and physical random access channel (PRACH), data, transmissions from the UE 116 including transmissions for a particular resource element (RE) upon which the UL transmission is made. In other embodiments, the transmission power value(s) may correspond demodulation reference signal (DMRS) transmissions including transmissions for a particular resource element (RE) upon which the DMRS transmission is made.

NR UL power control is based on a combination of open-loop power control (OLPC) and closed-loop power control (CLPC) components. OLPC includes support for fractional pathloss compensation where the UE 116 estimates a pathloss to a serving gNB, based on measurements for DL signals/channels from the serving gNB, and accordingly adjusts a transmission power. CLPC is based on transmit power control (TPC) commands provided by the gNB 102 where, for example, the gNB 102 may determine values for the TPC commands to the UE 116 based on measurements of the received power for transmissions from the UE 116. The NR UL power control procedure also supports beam-based power control.

If a UE transmits a PUSCH on active UL bandwidth part (BWP) b of carrier f of serving cell c using parameter set configuration with index j and PUSCH power control adjustment state with index l, the UE 116 determines the PUSCH transmission power P_{PUSCH,b,f,c} (i, j, q_{d}, l) in dBm in PUSCH transmission occasion i as,

$${P}_{PUSCH , b , f , c} ( i , j , {q}_{d} , l ) - min \{ \begin{matrix}{P}_{CMAX , f , c} ( i ) , \\ \begin{matrix}{P}_{O\_PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \}$$

P_{CMAX}(.) is the configured maximum UE output power per carrier. P₀(.) corresponds to a normalized target received power level value that may be indicated by a serving gNB using one or multiple signaled higher layer parameters. PL (.) corresponds to a pathloss estimate by the UE 116, for example based on an SSB or a non-zero power (NZP) CSI-RS. α(.) is a parameter for fractional pathloss compensation that is indicated by the serving gNB. M_{RB}(.) corresponds to the number of RBs for the PUSCH transmission when adjusting a normalized (per RB and 15 kHz SCS) target receive power. Δ_{TF}(.) may be associated with to a modulation scheme and channel-coding rate used for the data information provided by the PUSCH transmission and can be viewed as modeling link capacity such as 80% of Shannon capacity. This term may not always be included when determining a PUSCH transmit power and can be applicable only for single-layer UL transmissions. f(.) corresponds to a power adjustment state due to the CLPC component.

The configured maximum output power P_{CMAX,f,c} is set within the following bounds: P_{CMAX_L,f,c}≤P_{CMAX,f,c}≤P_{CMAX_H,f,c} with P_{CMAX_L,f,c}=MIN {P_{EMAX,c}−ΔT_{C,c}, (P_{PowerClass}−ΔP_{PowerClass})−MAX(MAX(MPR_{c}+ΔMPR_{c}, A-MPR_{c})+ΔT_{IB,c}+ΔT_{C,c}+ΔT_{RxSRS}, P-MPR_{c})} and P_{CMAX_H,f,c}=MIN {P_{EMAX,c}, P_{PowerClass}−ΔP_{PowerClass}} as described in REF8. Here, P_{EMAX,c} is provided by higher layer provided parameter p-Max or by the field additionalPmax of the higher layer parameter NR-NS-PmaxList, as described in REF6, and P_{PowerClass} is the maximum UE power of the applicable UE power class specified in REF8 without evaluating the tolerances specified in REF8. The parameter p-Max (range from −30 . . . 33) is used to limit the UE 116's transmission power on a carrier frequency and may also be used for the UE 116 to calculate compensation factors during cell (re-)selection in RRC_IDLE and/or RRC_INACTIVE states. p-Max is the maximum transmit power allowed in a serving cell with value in dBm.

In addition to limiting a UE transmit power on a serving cell, a total UE transmit power over all serving cells for the UE 116 may also be limited. Such a limitation of the UE 116 transmit power over multiple UL carriers may also be needed in case of LTE/NR dual connectivity. For example, a maximum transmit power that the UE 116 may use on a serving cell may be additionally limited by parameters p-NR-FR1 configured for the cell group and p-UE-FR1 configured total power for all serving cells operating on FR1. If absent, the UE 116 applies the maximum power according to REF8 in case of an FR1 cell or an FR2 cell.

The sum P₀(.)+α(.) PL(.) is associated with OLPC and, for α(.)<1, it includes fractional pathloss compensation. For full pathloss compensation (α(.)=1), OLPC adjusts the PUSCH transmit power such that the received power aligns with the target received power P₀(.). For example, P₀(.) may be selected and indicated by the gNB 102 to the UE 116 depending on the target data rate and/or the noise and interference level experienced at the gNB 102 receiver for the UE 116. For fractional pathloss compensation (α(.)<1), pathloss is not fully compensated while interference to neighbor cells is reduced. The gNB 102 received power for transmissions from a UE may, on average, vary depending on the UE 116 location within the serving cell. For example, for partial pathloss compensation, PUSCH transmissions from UEs experiencing larger pathloss, due to being at larger distances from the gNB 102, may be received by the gNB 102 with lower power that PUSCH transmissions from UEs experiencing smaller pathloss. The gNB 116 may compensate by adjusting the UL data rate of UEs accordingly and operate UEs located closer to the gNB 102 with larger data rates than UEs located further from the gNB 102. In consequence, there may be larger variations in the service quality and reduced data rate availability for UEs further from the gNB 102 (closer to the cell border) when using fractional pathloss compensation.

NR UL transmit power control procedures support beam-based power control. For example, a UE can be configured multiple DL reference signals for pathloss measurements, multiple OLPC parameter sets, and multiple CLPC processes.

In the case of beamforming, a pathloss estimate PL(.) that a UE uses to determine a transmit power should reflect the path loss, including the beamforming gains, of the paired UL beam that the UE 116 uses to transmit a PUSCH. When DL/UL beam correspondence is assumed, the UE 116 can estimate the pathloss based on measurements for a DL reference signal that is transmitted by the gNB 102 over the corresponding paired DL beam. As the UL beam used for UL/DL beam pair may change across PUSCH transmissions, the UE 116 may need to maintain multiple pathloss estimates corresponding to different candidate UL/DL beam pairs. The gNB 102 can configure the UE 116 with a set, such as up to 4 of DL reference signals for pathloss measurements, such as SSBs and/or NZP CSI-RSs. The gNB 102 can also configure a mapping among SRS resource indicator (SRI) values and pathloss DL reference signals. A DCI format scheduling a PUSCH transmission can include a SRI field indicating one of the SRI values and the UE 116 uses a pathloss estimate obtained from the DL RS associated with the indicated SRI value to determine a pathloss value to apply for the determination of the transmit power for the PUSCH transmission.

A UE can be configured multiple, such as up to 30, OLPC parameter sets {P₀(.), α(.)}, each corresponding to a pair of values for a normalized target receive power level value and a fractional pathloss compensation coefficient. A UE may use parameter pair {P₀(1), α(1)} for PUSCH transmissions associated with configured grants while remaining parameter pairs are associated with PUSCH transmissions scheduled by DCI formats. The gNB 102 may associate each value of the SRI field in a DCI format with one of the indicated OLPC parameter set pairs. For example, the gNB 102 may select and indicate an OLPC parameter set using separate values for normalized target receive power level value and fractional pathloss compensation coefficient, respectively, for each UL beam that can be used by the UE 116 to transmit a PUSCH. For a PUSCH transmission before the UE 116 receives dedicated configuration for OLPC parameters, such as for a Msg3 PUSCH transmission or for a PUSCH transmission scheduled by a DCI format with cyclic redundancy check (CRC) scrambled by a temporary C-RNTI (TC-RNTI), fractional power control is not used, e.g., α(.)=1, and P₀(.) may be determined by the UE 116 based on received information in the configuration of the random-access procedure.

With respect to multiple OLPC parameter sets, NR supports for a UE to be configured with up to three values for the normalized target receive power P₀(.) resulting to up to three respective values for a PUSCH transmit power. A DCI format scheduling the PUSCH transmission can indicate one of the P₀(.) values for the UE 116 to use in determining a power for the PUSCH transmission. For example, a DCI format 0_1 or a DCI format 0_2 may be configured to include a OLPC parameter set indication field and its associated index values are indicated by higher layer signaling such parameter P0-PUSCH-Set-r16 as described in REF2 and REF6. The OLPC parameter set indication field has length 1 bit when the DCI format scheduling the PUSCH transmission also includes the SRI field and has length of 1 bit or 2 bits when the SRI field is not present. It is noted that the OLPC parameter set indication field indicates only the normalized target receive power setting P₀(.) and does not indicate the fractional pathloss coefficient α(.).

A UE can be configured with two SRS resource sets. Values of two SRS resource set indicator fields in a DCI format scheduling a PUSCH transmission can indicate a first and a second normalized target receive power P₀(.) from a first and a second OLPC parameter set p0-PUSCH-Alpha and p0-PUSCH-Alpha2, respectively, that is provided by higher layers. Determination of the target receive power and fractional pathloss compensation coefficient by the UE 116 is per SRI field as in the case of a single SRI field in the DCI format.

Furthermore, the UE 116 can be configured with multiple, such as 2, independent CLPC processes. Similar to having multiple pathloss DL reference signals and multiple OLPC parameter sets, the selection of the associated CLPC process by the UE 116 can be configured by higher layers for the SRI value indicated by the DCI format.

The corresponding transmit power procedures for PUCCH, SRS or PRACH transmission are further described in REF3.

When evaluating UL power control in a full-duplex wireless communication system, several issues of existing state-of-the-art technology need to be overcome.

It should be viewed that a power for PUSCH transmissions in normal UL (or non-sub-band full duplex (SBFD)) slot(s)/symbol(s) and the full-duplex (or SBFD) slot(s)/symbol(s) may need to be controlled separately. Separate UL power control may also be necessary for different SBFD slot(s)/symbol(s). Adjustment and control by the gNB 102 for the power of a PUSCH transmission by a UE on a slot/symbol is based on appropriate parameterization of the allowed or configured UE maximum output power, OLPC parameter sets including target received power and fractional pathloss compensation coefficient, and CLPC processes. For brevity, the present disclosure views PUSCH transmissions and same principles can apply for PUCCH or SRS transmissions on non-SBFD slots/symbols versus on SBFD slots/symbols.

A gNB receiver in a full-duplex or SBFD wireless communication system may use a different number of receiver antennas, a different effective receiver antenna aperture area, and/or different receiver antenna directivity settings for receptions in a normal UL slot/symbol, i.e., non-SBFD slot/symbol, when compared to receptions in an UL subband of an SBFD slot/symbol. Note that similar evaluations may apply for gNB transmissions on non-SBFD slots/symbols when compared to the gNB 102 transmissions in DL sub-bands of a SBFD slot/symbol. Therefore, there is a need to adjust the UE 116 transmit power separately for the non-SBFD and for the SBFD slots/symbols.

Furthermore, in order to prevent possible gNB receiver-side automatic gain control (AGC) blocking and to enable effective implementation of serial interference cancellation (SIC) during receptions in the UL subband of an SBFD slot/symbol, corresponding Rx power target levels for transmissions from a UEs in an UL sub-band of an SBFD slot/symbol may need to be adjusted separately from the Rx power target levels for transmissions from the UE 116 in non-SBFD slots/symbols. Therefore, there is another need to adjust the UE 116 UL transmit power separately for the non-SBFD or SBFD slot(s)/symbol(s).

Furthermore, the transmission power from a UE in an UL subband of an SBFD slot/symbol determines the interference range of an aggressor UE with respect to co-scheduled UEs in the same cell and in adjacent cells. When a same transmit power is used by the UE 116 for the non-SBFD slots/symbols and for the SBFD slots/symbols, corresponding interference ranges of a transmission from the UE 116 in those slots are then also same. For full-duplex or SBFD operation on the serving cell, it is beneficial to limit the interference range of the UE 116 transmitting in an UL sub-band using an SBFD slot/symbol when compared to a transmission using a non-SBFD slot/symbol. The aggressor UE transmitting in the SBFD slot interferes with the victim UE receiving in the DL of the same serving cell and/or adjacent cells. The aggressor UE transmitting in the non-SBFD slot/symbol does not interfere with DL receptions by UEs in the same serving cell and in adjacent cells assuming that a same TDD UL-DL frame configuration is used by the cells in a deployment and assuming that a guard period is sufficiently large. Therefore, there is another need to adjust the UE 116 transmit power separately for non-SBFD slots/symbols and for SBFD slots/symbols.

A first issue relates to the use of fractional pathloss compensation coefficients α(.) when indicating and using the OLPC parameter sets {P₀(.), α(.)}. Using existing technology, a gNB cannot control and adjust the OLPC parameters according to the needs and operational characteristics of the full-duplex or SBFD wireless communication system.

Using existing technology, an SRS resource indicator (SRI) field may be configured by a serving gNB in a DCI format for scheduling PUSCH transmissions from a UE. When an SRI value is indicated by the DCI format to the UE 116, the associated OLPC parameter set pair is used by the UE 116 to determine a normalized target receive power level value and fractional pathloss compensation coefficient for the power of the PUSCH transmission. However, an availability of the SRI field is subject to UE feature implementation and the SRI may not always be assumed available for use. For example, support of SRI is not mandatory for FR1 operation due to dependency for the support of the feature on UL MIMO support by the UE 116. When the OLPC parameter set indication (OLPC PSI) field is included in a DCI format for the UE 116, only an associated normalized target receive power level value but not an associated fractional pathloss compensation coefficient can be determined by the UE 116 for the power of the PUSCH transmission. Efficient support for fractional pathloss compensation including the possibility to apply separate settings for the fractional pathloss compensation coefficient α(.) is required in the full-duplex wireless communication system.

For example, an UL sub-band of SBFD slots/symbols in the full-duplex wireless communication system may be allocated to cell edge UEs for purpose of extending UL coverage. Accordingly, a repetition of a PUSCH or a PUCCH transmission may then be configured for a UE. In some SBFD slots/symbols, full pathloss compensation may be beneficial/preferable when UE-to-UE CLI conditions allow to achieve a large UL link budget improvement for the cell-edge UE, while partial pathloss compensation may be beneficial/preferable in other SBFD slots/symbols to control system-level throughput and spectral efficiency while accepting a smaller UL link budget for the UE 116.

A second issue relates to indication and use of OLPC parameter sets {P₀(.), α(.)} for configured grant (CG) PUSCH transmissions (or periodic PUCCH/SRS) transmissions by a UE. Using existing technology, the gNB 102 cannot control and adjust the OLPC parameters according to the needs and operational characteristics of the full-duplex or SBFD wireless communication system.

Using existing technology, only OLPC parameter set pair {P₀(1), α(1)} may be used for a CG PUSCH transmission while the remaining parameter pairs are associated with PUSCH transmissions scheduled by a DCI format. A same setting for the normalized target receive power level value and a same setting for the fractional pathloss compensation coefficient is then used by the UE 116 to determine the power of the CG PUSCH transmission in any slot/symbol of the full-duplex wireless communication system, e.g., in any non-SBFD or SBFD slot/symbol. Separate normalized target receive power levels and fractional pathloss compensation coefficients for the power of the PUSCH transmission may be required for the PUSCH transmission in a non-SBFD slot/symbol when compared to the PUSCH transmission in the UL subband of an SBFD slot/symbol when evaluating gNB-side SBFD panel design, SIC and CLI constraints. Similar, for a PUCCH transmission, full pathloss compensation is supported while it can be beneficial to support partial pathloss compensation at least in SBFD slots/symbols.

Therefore, embodiments of the present disclosure recognize there is need for novel methods and enhanced procedures enabling to indicate, control and adjust the OLPC parameter sets {P₀(.), α(.)} for transmit power control of PUSCH transmissions, PUCCH transmissions, or SRS transmissions from a UE in a full-duplex or SBFD wireless communication system.

The present disclosure evaluates methods where open loop power control parameters or parameter sets are provided to the UE 116 and the UE 116 selects an open-loop power control parameter or parameter set for PUSCH transmission based on non-SBFD/SBFD slot/symbol type or based on an SBFD subband type.

In various embodiments, fractional pathloss compensation coefficient alpha provided by new Rel-19 RRC configuration when configuring UE behavior such that the Rel-16 Open loop power control parameter set indication field in DCI F0_1/0_2 can be used to indicate separate p0/alpha settings for PUSCH transmissions in non-SBFD/SBFD slots or for an SBFD subband.

In additional embodiments, separate open loop parameter set configurations (=p0/alpha) provided to UE for configured grant PUSCH transmissions in non-SBFD/SBFD slots.

In yet additional embodiments, applicable open-loop parameter set, target receive power level value p0, or fractional pathloss compensation coefficient alpha determined by UE based on slot type or non-SBFD/SBFD in a slot.

In one embodiment, the UE 116 is provided by higher layers a set of fractional pathloss compensation coefficients α_{b,f,c}(j) for an active BWP b of carrier f of serving cell c and selects a coefficient α_{b,f,c}(j) from the set of coefficients to determine a power for a PUSCH transmission in an SBFD subband of an SBFD slot/symbol or non-SBFD slot/symbol based on an indication by DCI format scheduling the PUSCH transmission. For example, an SBFD subband may correspond to an UL subband.

For example, the UE 116 may be provided a set of fractional pathloss compensation coefficient(s) α_{b,f,c}(j) using a higher layer parameter P0-PUSCH-AlphaSet where P0-PUSCH-AlphaSet may contain parameters of a sequence of values for p0-PUSCH-AlphaSetId, p0, alpha.

In another example, the UE 116 may be provided the set of coefficients α_{b,f,c}(j) using a higher layer parameter P0-PUSCH-Set-r19 where P0-PUSCH-Set-r19 may contain parameters of a sequence p0-PUSCH-SetId-r19, p0-List-r19, alpha-List-r19. A parameter p0-List-r19 may be provided as sequence of size 1 to maxNrofP0-PUSCH-Set-r19 including elements P0-PUSCH-r19. A parameter alpha-List-r19 may be provided as sequence of size 1 to maxNrofAlpha-PUSCH-Set-r19 including elements Alpha-PUSCH-r19.

For example, the UE 116 may determine a coefficient α_{b,f,c}(j) from the set of coefficients for a PUSCH transmission based on an indication by an SRI field in a DCI format scheduling the PUSCH transmission or based on an OLPC parameter set indication field in the DCI format or based on a combination of an SRI field an OLPC parameter set indication field in the DCI format.

In one exemplary procedure, the UE 116 is configured with an OLPC parameter set indication field for a DCI format scheduling a PUSCH transmission and an SRI field is not configured for the DCI format. The UE 116 is provided by higher layers a set for target receive power P_{0_UE_PUSCH,b,f,c}(j) values provided as set of p0 and a set of fractional pathloss compensation coefficient(s) @b,f,c(j) provided as set of alpha using P0-PUSCH-AlphaSet. This example corresponds to a case where a an RRC configuration for UE behavior upon reception of an SRI field in a DCI format is now used for UE behavior in SBFD operation based on reception of an OLPC parameter set indication field in the DCI format.

In another exemplary procedure, a UE is configured an OLPC parameter set indication field for an DCI format scheduling a PUSCH transmission and an SRI field is not configured for the DCI format. The UE 116 is provided by higher layers a set for target receive power P_{0_UE_PUSCH,b,f,c}(j) values provided as set of P0-PUSCH-r19 and a set of fractional pathloss compensation coefficients α_{b,f,c}(j) provided as set of Alpha-PUSCH-r19 using p0-List-r19. This example corresponds to a case where an RRC configuration for UE behavior upon reception of an OLPC parameter set indication field in a DCI format is now extended for Rel-19 SBFD based on reception of a OLPC parameter set indication field in the DCI format. The P0-PUSCH-r16 parameter may correspond to a P0-PUSCH-Set-r16 as sequence of values for p0-PUSCH-SetId-r16 and P0-PUSCH-r16. The P0-PUSCH-r19 parameter may reuse these parameters and may be extended by associated sequence values for Alpha-PUSCH-r19.

When the UE 116 receives the DCI format with the OLPC parameter set indication field, the UE 116 determines an OLPC parameter pair {P₀(.), α(.)} to use for determining a power for the PUSCH transmission based on P0-PUSCH-AlphaSet or on P0-PUSCH-r19 associated with the value provided for the OLPC parameter set indication field. For example, the UE 116 may select a parameter pair, or may assume a default value such a j=0 or j=2.

With reference to detailed procedures, the UE 116 determines a fractional pathloss compensation coefficient, α_{b,f,c}(j) using an OLPC parameter set indication field in a DCI Format 0_1 or 0_2. For j∈S_{J}, α_{b,f,c}(j) a set of values are provided by a set of alpha in P0-PUSCH-AlphaSet indicated by a respective set of p0-PUSCH-AlphaSetId for active UL BWP b of carrier f of serving cell c.

When an SRI field is included in a DCI format scheduling a PUSCH transmission from a UE, e.g., if the UE 116 is provided SRI-PUSCH-PowerControl and more than one values of p0-PUSCH-AlphaSetId, the UE 116 obtains a mapping from sri-PUSCH-PowerControlId in SRI-PUSCH-PowerControl between a set of values for the SRI field in the DCI format as defined by REF2 and a set of indexes provided by p0-PUSCH-AlphaSetId that map to a set of P0-PUSCH-AlphaSet values. The UE 116 also determines the values of α_{b,f,c}(j) from the p0-PUSCH-AlphaSetId value that is mapped to the SRI field value if the PUSCH transmission, except for the PUSCH retransmission corresponding to a RAR UL grant, is scheduled by a DCI format that does not include an SRI field, or if SRI-PUSCH-PowerControl is not provided to the UE 116, j=2, and the UE 116 determines α_{b,f,c}(j) from the value of the first P0-PUSCH-AlphaSet in p0-AlphaSets.

When an SRI field is not included in the DCI format scheduling a PUSCH transmission from a UE, or if SRI-PUSCH-PowerControl is not provided to the UE 116, a default value may be assumed, e.g., j=0 or j=2.

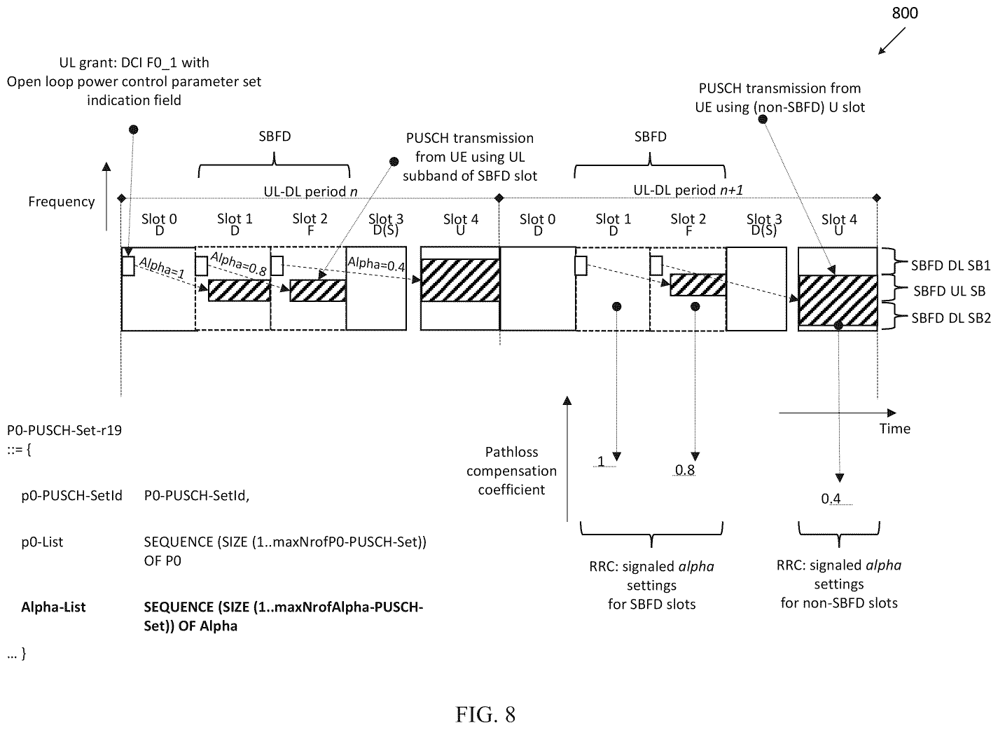

FIG. 8 illustrates a timeline 800 for PUSCH transmission(s) according to embodiments of the present disclosure. For example, timeline 800 for PUSCH transmission(s) can be followed by the UE 116 of FIG. 3. This example is for illustration only and other embodiments can be used without departing from the scope of the present disclosure.

When an P0-PUSCH-AlphaSet is provided to the UE 116 and the DCI format includes an OLPC parameter set indication field, the UE 116 may determine a value of α_{b,f,c}(j) from a first P0-PUSCH-AlphaSet if a value of the OLPC parameter set indication field is ‘0’ or ‘00’, a value in P0-PUSCH-AlphaSet with the lowest p0-PUSCH-AlphaSetId value if a value of the OLPC parameter set indication field is ‘1’ or ′01, or a second value in P0-PUSCH-AlphaSet with the lowest p0-PUSCH-AlphaSetId value if a value of the OLPC parameter set indication field is ‘10’; else, the UE 116 may determine α_{b,f,c}(j) from the value of the first P0-PUSCH-AlphaSet.

For example, a first fractional pathloss compensation coefficient α=1 or full pathloss compensation may be configured for PUSCH transmissions from a UE on the UL subband of an SBFD slot while α=0.7 or partial pathloss compensation may be configured for PUSCH transmission from the UE 116 in a non-SBFD slot on the serving cell and where a value for α(.) associated with the power of a PUSCH transmission is determined by the UE 116 based on the reception of an OLPC parameter set indication field in the DCI format.

It is one advantage of the solution that the UE 116 can be configured with OLPC parameter sets {P₀(.), α(.)} each corresponding to a pair of values for a normalized target receive power level value and a fractional pathloss compensation coefficient for operation on a serving cell supporting full-duplex or SBFD operation. Separate OLPC parameter sets and, in particular, separate fractional pathloss compensation coefficients can be configured and signaled/indicated to the UE 116 by the gNB 102 for use in normal UL (or non-SBFD) slots/symbols and the full-duplex (or SBFD) slots/symbols, respectively, or for use in different SBFD subbands. Similarly, separate OLPC parameter sets and, in particular, separate fractional pathloss compensation coefficients can be configured and signaled/indicated for different SBFD slots/symbols or for different SBFD subbands.

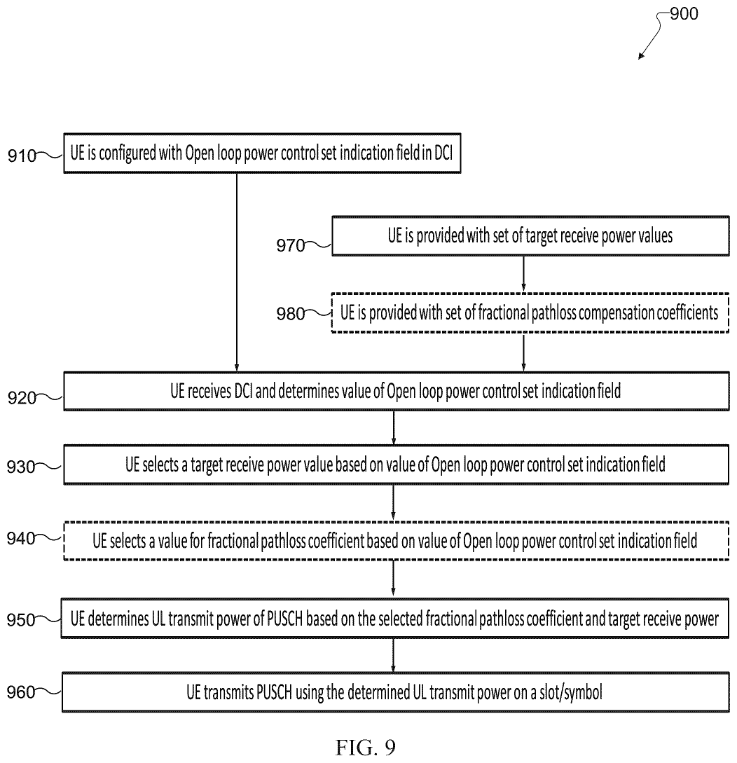

FIG. 9 illustrates a flowchart of an example UE procedure 900 for PUSCH transmission(s) according to embodiments of the present disclosure. For example, procedure 900 for PUSCH transmission(s) can be performed by an of the UEs 111-1116 of FIG. 1. This example is for illustration only and other embodiments can be used without departing from the scope of the present disclosure.

The procedure begins in 910, a UE is configured with open loop power control set indication field in DCI. In 920, the UE receives DCI and determines the value of Open loop power control set indication field. In 930, the UE selects a target receive power value based on the value of Open look power control set indication field. In 940, the UE selects a value for fractional pathloss coefficient based on the value of Open look power control set indication field. In 950, the UE determines UL transmit power of PUSCH based on the selected fractional pathloss coefficient and target receive power. In 960, the UE transmits PUSCH using the determines UL transmit power on a slot/symbol. Alternatively, the procedure can begin in 970, a UE is provided with a set of target receive power values. In 980, the UE is provided with a set of fractional pathloss compensation coefficients. The procedure then resumes in 920.

In one embodiment, the UE 116 determines a first OLPC parameter set {P₀(i), α(i)} and a second OLPC parameter set {P₀(j), α(j)} for a CG PUSCH transmission in an SBFD subband of an SBFD slot/symbol and in a non-SBFD slot/symbol, respectively. For example, an SBFD subband may correspond to an UL subband. A first and a second OLPC parameter set may be provided to the LIE 116 by higher layer signaling, or by a DCI format scheduling or activating PUSCH transmissions, or tabulated in system specifications, or a combination of these methods may be used. The UE 116 may determine a default value for a first or a second OLPC parameter set {P₀(.), α(.)} or for both sets. The UE 116 may be provided by higher layer signaling a first OLPC parameter set {P₀(i), α(i)} and the UE 116 determines a second OLPC parameter set {P₀(j), α(j)} from system specifications using a default value.

For example, the UE 116 may be provided with a first and a second OLPC parameter set using higher layer parameter ConfiguredGrantConfig where a first target receive power level P₀(i) may be provided by parameters p0-NominalWithoutGrant or p0 and where a second target receive power level P₀(j) may be provided by parameters p0-NominalWithoutGrant2 or p0bis. Similarly, a first fractional pathloss compensation coefficient α(i) may be provided by parameter alpha and second fractional pathloss compensation coefficient α(j) may be provided by parameter alpha2 using higher layer parameter ConfiguredGrantConfig.

In another example, the UE 116 may be provided a set of OLPC parameter configurations. The UE 116 determines a first target receive power level P₀(i) based on system specifications, e.g., i=1, and determines a second target receive power level P₀(j) using parameters p0-NominalWithoutGrant or p0 based on higher layer ConfiguredGrantConfig. Similarly, the U E 116 may determine a first fractional pathloss compensation coefficient α(i) based on system specifications, e.g., i=1, and second fractional pathloss compensation coefficient α(j) may be provided by parameter alpha based on higher layer parameter ConfiguredGrantConfig.

With reference to detailed procedures, the UE 116 may determine P_{O_PUSCH,b,f,c}(j) as a parameter composed of the sum of a component P_{O_NOMINAL_PUSCH,f,c}(j) and a component P_{O_PUSCH,b,f,c}(j) where j∈{0,1, . . . , J−1}.

For a PUSCH (re-)transmission configured by higher layer parameter ConfiguredGrantConfig on a non-SBFD slot/symbol, j=1, P_{O_NOMINAL_PUSCH,f,c}(J) is provided by p0-NominalWithoutGrant, or P_{O_NOMINAL_PUSCH,f,c}(1)=P_{O_NOMINAL_PUSCH,f,c}(0) if p0-NominalWithoutGrant is not provided, and P_{O_UE_PUSCH,f,c}(1) is provided by p0 obtained from p0-PUSCH-Alpha in ConfiguredGrantConfig that provides an index P0-PUSCH-AlphaSetId to a set of P0-PUSCH-AlphaSet for active UL BWP b of carrier f of serving cell c. For a PUSCH (re-)transmission configured by higher layer parameter ConfiguredGrantConfig on an SBFD slot/symbol, j=2, P_{O_NOMINAL_PUSCH,f,c}(2) is provided by p0-NominalWithoutGrant2, or P_{O_NOMINAL_PUSCH,f,c}(2) P_{O_NOMINAL_PUSCH,f,c}(0) if p0-NominalWithoutGrant2 is not provided, and P_{O_NOMINAL_PUSCH,f,c}(2) is provided by p0bis obtained from p0-PUSCH-Alpha in ConfiguredGrantConfig that provides an index P0-PUSCH-AlphaSetId to a set of P0-PUSCH-AlphaSet for active UL BWP b of carrier f of serving cell c.

With reference to detailed procedures, the UE 116 determines a fractional pathloss compensation coefficient, α_{b,f,c}(j) using an OLPC parameter set indication field in a DCI Format 0_1 or 0_2. For j∈S_{J},α_{b,f,c}(j) a set of α_{b,f,c}(j) values are provided by a set of alpha in P0-PUSCH-AlphaSet indicated by a respective set of p0-PUSCH-AlphaSetId for active UL BWP b of carrier f of serving cell c.

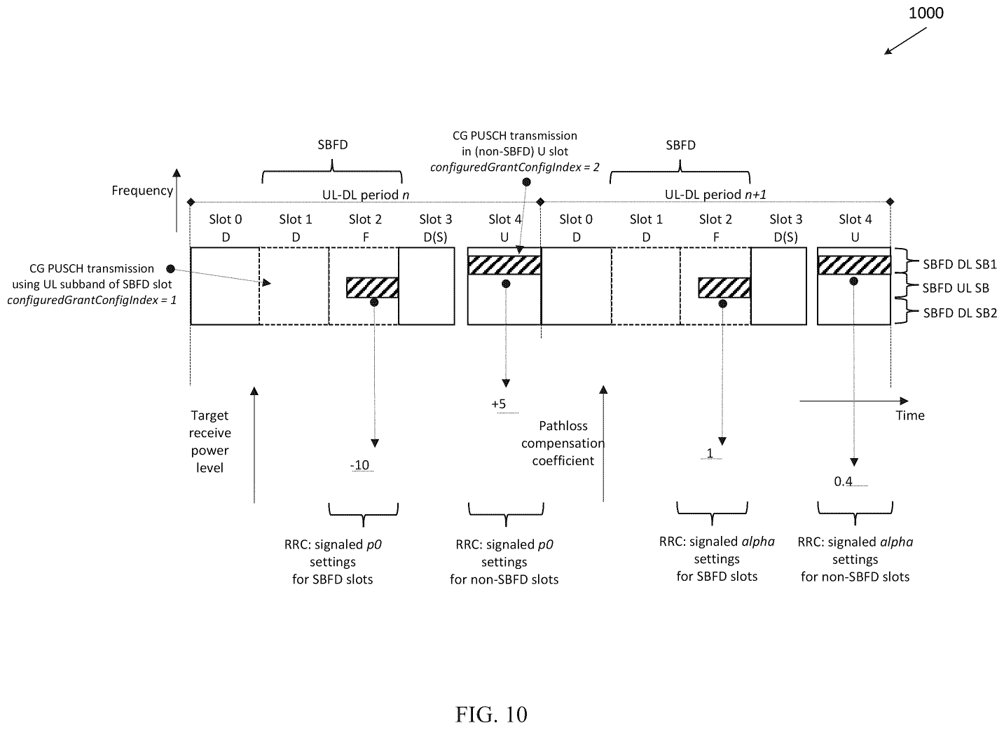

FIG. 10 illustrates a timeline 1000 for PUSCH transmission(s) according to embodiments of the present disclosure. For example, timeline 1000 for PUSCH transmission(s) can be followed by the UE 116 of FIG. 3. This example is for illustration only and other embodiments can be used without departing from the scope of the present disclosure.

For j=1, α_{b,f,c}(1) is provided by alpha obtained from p0-PUSCH-Alpha in ConfiguredGrantConfig on a non-SBFD slot/symbol providing an index P0-PUSCH-AlphaSetId to a set of P0-PUSCH-AlphaSet for active UL BWP b of carrier f of serving cell c. For j=2, α_{b,f,c}(2) is provided by alpha2 obtained from p0-PUSCH-Alpha in ConfiguredGrantConfig on an SBFD slot/symbol providing an index P0-PUSCH-AlphaSetId to a set of P0-PUSCH-AlphaSet for active UL BWP b of carrier f of serving cell c.

Use of indices j=1 and j=2 in the previous example is provided for illustration purposes only. The indices of a first OLPC parameter set {P₀(j=1), α(j=1)} and a second OLPC parameter set {P₀(j=2), α(j=2)} may be provided/indicated to the UE 116. Using j=1 for a first OLPC parameter set corresponds to the OLPC parameter and index assignment for CG PUSCH transmissions as by legacy NR procedures, e.g., and may be used for PUSCH transmissions in a normal (or non-SBFD) slot or symbol. For example, a second OLPC parameter set using j=15 may be provided/indicated by the gNB 102, instead of j=2, as index assignment for a CG PUSCH transmission on an SBFD slot/symbol. For example, a first and a second OLPC parameter set may be provided/indicated using indices j=12 and j=18, respectively. The provided or default index assignments for a normalized target receive power level and a fractional pathloss compensation coefficient {P₀(j), α(j)} may not need to be same for the non-SBFD and SBFD slots/symbols, respectively. For example, j=1 and j=12 may be indicated by the gNB 102 for the UE 116 to determine a first and a second target receive power level for CG PUSCH transmissions in a non-SBFD slot and SBFD slot, respectively, and j=20 and j=21 may be indicated by the gNB 102 for the UE 116 to determine corresponding first and second fractional pathloss compensation coefficients. Similar principles can extend to configuration, indication or default values for the first and second OLPC parameter set for CG PUSCH transmissions in different SBFD slots/symbols or in different SBFD subbands.

It is one advantage of the solution that the UE 116 can be configured with separate OLPC parameter sets {P₀(.), α(.)} each corresponding to a pair of values for a normalized target receive power level and a fractional pathloss compensation coefficient for CG PUSCH transmissions on a serving cell supporting full-duplex or SBFD operation. Separate OLPC parameter sets and, in particular, separate fractional pathloss compensation coefficients can be configured and indicated to the UE 116 by the gNB 102 for use in normal UL (or non-SBFD) slots/symbols and the full-duplex (or SBFD) slots/symbols, respectively, or for different SBFD subbands. Similarly, separate OLPC parameter sets and, in particular, separate fractional pathloss compensation coefficients can be configured and indicated for different SBFD slots/symbols or for different SBFD subbands.

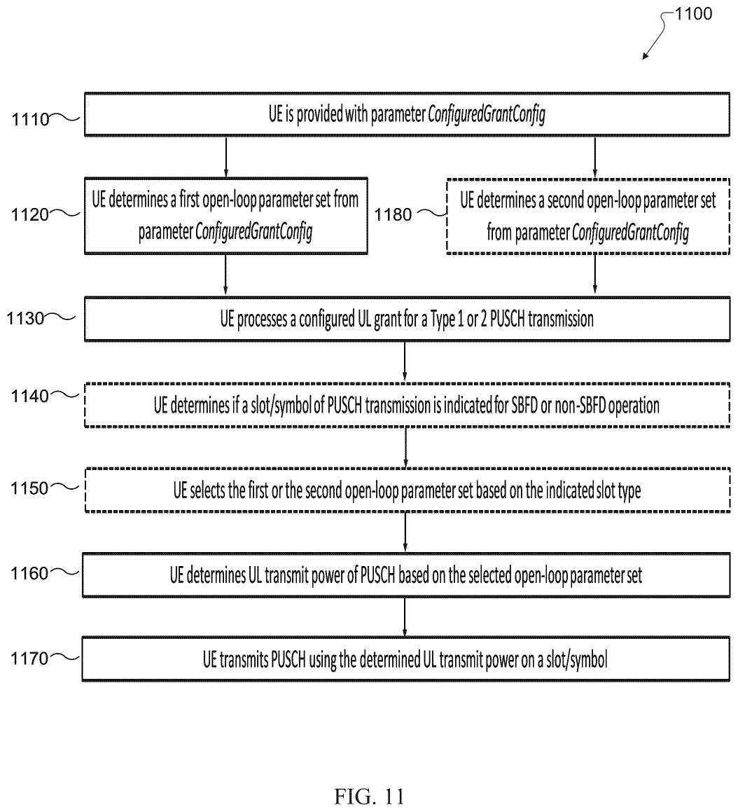

FIG. 11 illustrates a flowchart of an example UE procedure 1100 for configured grant PUSCH transmission(s). For example, procedure 1100 for configured grant PUSCH transmission(s) can be performed by an of the UEs 111-116 of FIG. 1. This example is for illustration only and other embodiments can be used without departing from the scope of the present disclosure.

The procedure begins in 1110, a UE is provided with a parameter ConfiguredGrantConfig. In 1120, the UE determines a first open-loop parameter set from the parameter ConfiguredGrantConfig. In 1130, the UE processes a configured UL grant for a Type 1 or 2 PUSCH transmission. In 1140, the UE determines if a slot/symbol of PUSCH transmission is indicated for SBFD or non-SBFD operation. In 1150, the UE selects the first or the second open-loop parameter set based on the indicated slot type. In 1160, the UE determines a UL transmit power of PUSCH based on the selected open-loop parameter set. In 1170, the UE transmits PUSCH using the determined UL transmit power on a slot/symbol. Alternatively, or additionally after 1110, in 1180, the UE determines a second open-loop parameter set from parameter ConfiguredGrantConfig and then resumes in 1130.

In one embodiment, a LIE determines or selects an OLPC parameter set {P₀(i), α(i)} or a target receive power level P₀(i) or a fractional pathloss compensation coefficient α(i) for a PUSCH transmission in a slot/symbol based on a slot/symbol type or based on an SBFD subband type.

The UE 116 determines a first OLPC parameter set {P₀(i), α(i)} or a first target receive power level P₀(i) or a first fractional pathloss compensation coefficient α(i) and a second OLPC parameter set {P₀(j), α(j)} or a second target receive power level P₀(j) or a second fractional pathloss compensation coefficient α(j) for PUSCH transmission on a serving cell on non-SBFD slots/symbols and SBFD slots/symbols, respectively. The first OLPC parameter set, or target receive power or fractional pathloss compensation coefficient for a serving cell is associated with PUSCH transmissions by the UE 116 in a first set of slots of the serving cell operating SBFD. The second OLPC parameter set, or target receive power or fractional pathloss compensation coefficient for a serving cell is associated with PUSCH transmissions by the UE 116 in a second set of slots on the serving cell not operating SBFD. An OLPC parameter set may be used by the UE 116 to determine parameters for PUSCH transmission in one or multiple slots where the parameters may include a target receive power level or fractional pathloss compensation coefficient. A first or a second OLPC parameter set or target or receive power or fractional pathloss compensation coefficient associated with the parameters for PUSCH transmissions in sets of slots may be provided to the UE 116 by one or a combination of L1 control signaling such as a DCI format, RRC signaling and/or configuration, tabulated and/or listed by system operating specifications, or MAC CE signaling. Only a first OLPC parameter set or target receive power or fractional pathloss compensation coefficient associated with the PUSCH transmission may be provided to the UE 116 by s DCI format whereas a second OLPC parameter set or target receive power or fractional pathloss compensation coefficient for the PUSCH transmission may be determined by the UE 116 by, e.g., from RRC, MAC CE or from system specifications. The determination of a second OLPC parameter set or target receive power or fractional pathloss compensation coefficient for PUSCH transmission by the UE 116 may depend on and be a function of a first OLPC parameter set or target receive power or fractional pathloss compensation coefficient, e.g., the UE 116 determines a value for a parameter from the second OLPC parameter set as a relative value compared to or as offset to a value for a parameter from the first OLPC parameter set.

In one example, a flexible slot/symbol/subband may be used for SBFD operation by the gNB 102. The gNB 102 may provide an SBFD subband configuration to the UE 116 for the flexible symbol/slot. A SBFD subband configuration may include an UL subband or a DL subband. The gNB 102 may schedule a PUSCH transmission from a UE in the flexible symbol/slot. When the UE 116 determines the flexible slot/symbol/subband to be scheduled or configured by the gNB 102 for DL-only, e.g., for non-full-duplex or non-SBFD receptions by the UE 116, the UE 116 determines/selects a first OLPC parameter set {P₀(i), α(i)} or a first target receive power level P₀(i) or a first fractional pathloss compensation coefficient α(i) to determine the power of the PUSCH transmission in slot/symbol. When the UE 116 determines the flexible slot/symbol/subband to be scheduled or configured by the gNB 102 for DL receptions and UL transmissions, e.g., for full-duplex or SBFD transmissions and receptions, the UE 116 determines/selects a second OLPC parameter set {P₀(j), α(j)} or a second target receive power level P₀(j) or a second fractional pathloss compensation coefficient α(j) to determine the power of the PUSCH transmission in the slot/symbol. When the UE 116 receives a DCI format scheduling a transmission or a reception in a slot/symbol, the UE 116 determines/selects an OLPC parameter set, a target receive power level or a fractional pathloss compensation coefficient using an associated slot/symbol index of the OLPC parameter set, the target receive power level or the fractional pathloss compensation coefficient in that slot or symbol.

In another example, a DL slot/symbol s₁ may be used for SBFD operation by the gNB 102. The gNB 102 may provide an SBFD subband configuration to the UE 116 for the DL symbol/slot s₁. An SBFD subband configuration may include an UL subband or a DL subband. The gNB 102 may schedule a PUSCH transmission from the UE 116 on the SBFD UL subband of the DL symbol/slot s₁. When the UE 116 determines the DL slot/symbol s₁ to be scheduled or configured by the gNB 102 for SBFD transmissions from the UE 116 using the UL subband, e.g., for full-duplex or SBFD transmissions and receptions by the gNB 102, the UE 116 selects a first OLPC parameter set {P₀(i), α(i)} or a first target receive power level P₀(i) or a first fractional pathloss compensation coefficient α(i) to determine the power of the PUSCH transmission in slot/symbol s₁. When the UE 116 determines another slot/symbol s₂ to be scheduled or configured by the gNB 102 for PUSCH transmissions from the UE 116, e.g., on another full-duplex or SBFD slot/symbol s₂ for transmissions and receptions by the gNB 102 or on another non-full-duplex or non-SBFD slot/symbol s₂ for receptions by the gNB 102, the UE 116 determines/selects a second OLPC parameter set {P₀(j), α(j)} or a second target receive power level P₀(j) or a second fractional pathloss compensation coefficient α(j) to determine the power of the PUSCH transmission in slot/symbol s₂. When the UE 116 receives a DCI format scheduling transmission or reception on a slot/symbol, the UE 116 determines/selects an OLPC parameter set, a target receive power level or a fractional pathloss compensation coefficient using an associated slot/symbol index of the OLPC parameter set, and/or the target receive power level or the fractional pathloss compensation coefficient in that slot or symbol. The principles extend to the case where another slot/symbol s₂ used to schedule PUSCH transmissions from the UE 116 is another DL slot/symbol.

The UE 116 may determine/select an OLPC parameter set, a target receive power level or a fractional pathloss compensation coefficient to determine the power of a PUSCH transmission on a slot/symbol based on a slot/symbol type in a time period. The slot type may include one or a combination of the following:
slot or symbol of type D (Downlink), U (Uplink) or F (Flexible) in a TDD common or dedicated UL-DL frame configuration or provided through slot formation indication (SFI) such as in DCI format 2_0;
slot or symbol of type ‘simultaneous Tx-Rx’, ‘Rx only’, or ‘Tx only’, e.g., associated with a cell common or a UE dedicated slot and/or symbol configuration providing a resource or transmission type indication;
slot or symbol associated with a full-duplex UL transmission resource or SBFD UL subband configuration or a full-duplex DL transmission resource or SBFD DL subband configuration; and/or
slot or symbol assignment provided to the UE 116 by DCI scheduling.

For example, the UE 116 determines/selects an OLPC parameter set, a target receive power level, or a fractional pathloss compensation coefficient using a configured slot or symbol index that is provided as resource type indication by a higher layer parameter in fd-config.

For example, the UE 116 may determine the resource type configuration of a serving cell by receiving a system information block (SIB), such as a SIB1, or by a common RRC signaling, or by UE-specific RRC signaling. A resource type indication provided to the UE 116 by higher layers indicates that a slot or symbol or symbol group of the transmission resource may be of type ‘simultaneous Tx-Rx’, ‘Rx only’, or ‘Tx only’. For example, a transmission resource of type ‘simultaneous Tx-Rx’, ‘Rx only’, or ‘Tx only’ can be provided per slot type ‘D’, ‘U’ or ‘F’ in a slot. For example, the transmission resource may be configured with an SBFD UL and/or DL subband. The indication of the resource type may be provided independently of the transmission direction of a slot or symbol indicated to the UE 116 by the TDD UL-DL frame configuration provided by higher layers.

If the determined slot or symbol type of a slot/symbol for determination of the UL transmit power is ‘non-SBFD’, the UE 116 determines/selects a first OLPC parameter set {P₀(i), α(i)} or a first target receive power level P₀(i) or a first fractional pathloss compensation coefficient α(i). If the determined slot or symbol type of a slot or symbol for determination of the transmit power is ‘SBFD’, the IE 116 determines/selects a second OLPC parameter set {P₀(j), α(j)} or a second target receive power level P₀(j) or a second fractional pathloss compensation coefficient α(j).

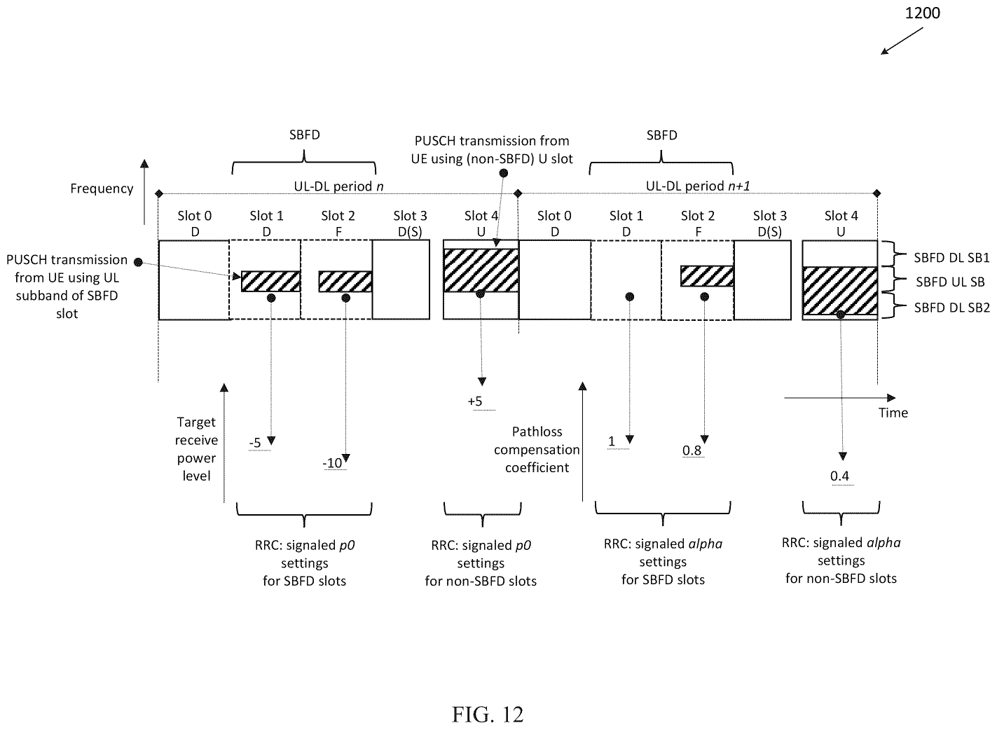

FIG. 12 illustrates a timeline 1200 for PUSCH transmission(s) according to embodiments of the present disclosure. For example, timeline 1200 for PUSCH transmission(s) can be followed by the UE 116 of FIG. 3. This example is for illustration only and other embodiments can be used without departing from the scope of the present disclosure.

A motivation for the UE behavior described herein is that by determining a slot or symbol as type ‘non-SBFD’ versus ‘SBFD’, the gNB 102 may distinguish between slots/symbols in which only UL receptions occur and slots/symbols where both DL transmissions and UL receptions by the gNB 102 may occur. Accordingly, the gNB 102 can select and provide separate OLPC parameter settings adapted to the CLI conditions and the gNB 102 SIC implementation constraints for the UE 116 to determine an power for PUSCH transmissions on the full-duplex or SBFD slot/symbol.

In another example, selection of a first OLPC parameter set {P₀(i), α(i)} and a second OLPC parameter set {P₀(j), α(j)} associated with parameters for PUSCH transmission on non-SBFD slots/symbols or SBFD slots/symbols by the UE 116 may be based on an indication by a DCI format scheduling the PUSCH transmission. For example, the first OLPC parameter set may be indicated to the UE 116 by a first “SRS resource indicator” field in the DCI format and the second OLPC parameter set may be indicated to the UE 116 in a second “open loop power control parameter set indication” field in the DCI format. For example, the first OLPC parameter set is indicated to the UE 116 in a first “SRS resource indicator” field and the second OLPC parameter set is indicated to the UE 116 in a second “SRS resource indicator” field in the DCI format. For example, the first and second OLPC parameter sets may be indicated to the UE 116 using a new “SBFD power control set” field in the DCI format. The first and the second fields may be separate and allow for independent settings of the first or the second OLPC parameter sets associated with the parameters of the PUSCH transmission. Alternatively, the first and the second fields may be used in conjunction by the UE 116 to determine a first and a second OLPC parameter set. For example, the first and the second fields may have the same lengths, e.g., M₁=M₂=M=2 bits where M₁ denotes the length of the first field and M₂ denotes the length of the second field in the DCI format. In another example, the first and the second fields may have different lengths, e.g., M₁₌₃ bits but M₂<M₁, e.g., M₂=2 bits.

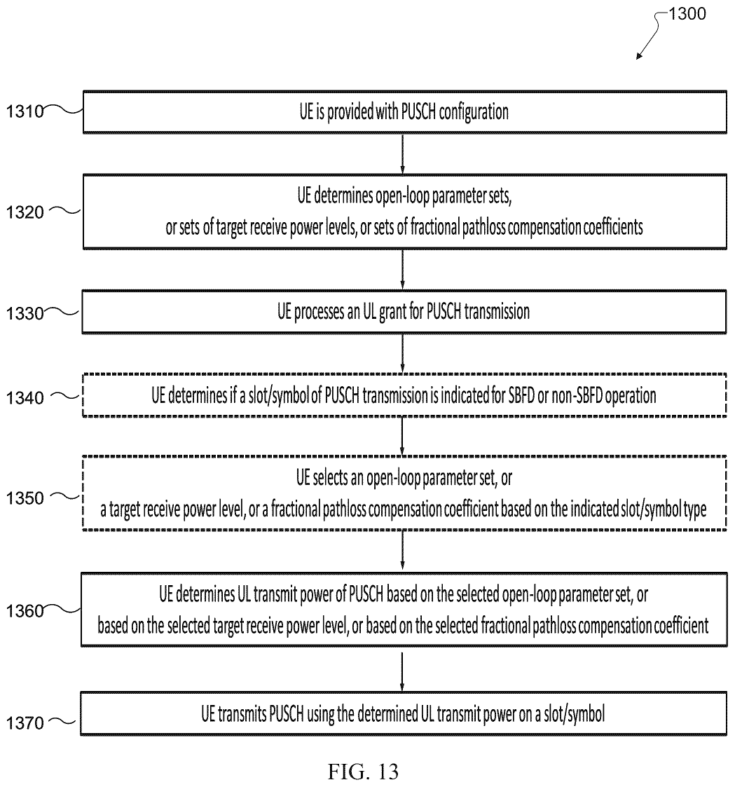

FIG. 13 illustrates a flowchart of an example UE procedure 1300 for PUSCH transmission(s) according to embodiments of the present disclosure. For example, procedure 1300 can be performed by any of the UEs 111-116 of FIG. 1. This example is for illustration only and other embodiments can be used without departing from the scope of the present disclosure.

The procedure begins in 1310, a UE is provided with a PUSCH configuration. In 1320, a UE determines open-loop parameter sets, sets of target receive power levels, or sets of fractional pathloss compensation coefficients. In 1330, a UE processes an UL grant for PUSCH transmission. In 1340, the UE determines if a slot/symbol of PUSCH transmission is indicated for SBFD or non-SBFD operation. In 1350, a UE selects an open-loop parameter set, a target receive power level, or a fractional pathloss compensation coefficient based on the indicated slot/symbol type. In 1360, a UE determines UL transmit power of PUSCH based on the selected open-loop parameter set, based on the selected target receive power level, or based on the selected fractional pathloss compensation coefficient. In 1370, the UE transmits PUSCH using the determined UL transmit power on a slot/symbol.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method of operating a user equipment (UE) for transmitting an uplink (UL) channel or signal, the method comprising:
receiving first information for a first set of power control parameters for a first UL channel or signal associated with a first subset of slots from a set of slots on a cell;
receiving second information for a second set of power control parameters for a second UL channel or signal associated with a second subset of slots from the set of slots on the cell;
determining, based on a slot for a transmission being from the second subset of slots, a first power control value from the second set of power control parameters for the transmission; and
transmitting, based on the first power control value, the second UL channel or signal in the slot,
wherein the first subset of slots does not include time-domain resources indicated for simultaneous transmission and reception on the cell, and
wherein the second subset of slots includes time-domain resources indicated for simultaneous transmission and reception on the cell.

2. The method of claim 1, wherein the first power control value is associated with a target receive power level value or a fractional pathloss compensation coefficient.

3. The method of claim 1, further comprising:
selecting, based on a type of symbol on which the second UL channel or signal is to be transmitted, a second power control value from the second set of power control parameters,
wherein transmitting the second UL channel or signal further comprises transmitting, based on the second power control value, the second UL channel or signal, and
wherein the type of symbol is one of a downlink (DL) symbol, an UL symbol, or a flexible symbol.

4. The method of claim 1, further comprising:
selecting, based on a frequency-domain subband in a transmission bandwidth in which the second UL channel or signal is to be transmitted, a second power control value from the second set of power control parameters,
wherein transmitting the second UL channel or signal further comprises transmitting, based on the second power control value, the second UL channel or signal, and
wherein the frequency-domain subband is one of an UL subband, a flexible subband, or an UL bandwidth part (BWP).

5. The method of claim 1, further comprising:
receiving an indication for a second power control value from the second set of power control parameters in a field of downlink control information (DCI); and
determining, based on the indication and the second set of power control parameters, a transmission power for the second UL channel or signal,
wherein transmitting the second UL channel or signal further comprises transmitting the second UL channel or signal based on the transmission power.

6. The method of claim 1, wherein the first power control value or a second power control value is associated with a configured grant physical uplink shared channel (PUSCH).

7. The method of claim 1, wherein the first power control value or a second power control value is associated with a power of a demodulation reference signal (DMRS) resource element (RE) or a data RE corresponding to a physical uplink shared channel (PUSCH) transmission.

8. A user equipment (UE) comprising:
a transceiver configured to:
receive first information for a first set of power control parameters for a first uplink (UL) channel or signal associated with a first subset of slots from a set of slots on a cell; and
receive second information for a second set of power control parameters for a second UL channel or signal associated with a second subset of slots from the set of slots on the cell; and
a processor operably coupled with the transceiver, the processor configured to determine, based on a slot for a transmission being from the second subset of slots, a first power control value from the second set of power control parameters for the transmission,
wherein the transceiver is further configured to transmit, based on the first power control value, the second UL channel or signal in the slot,
wherein the first subset of slots does not include time-domain resources indicated for simultaneous transmission and reception on the cell, and
wherein the second subset of slots includes time-domain resources indicated for simultaneous transmission and reception on the cell.

9. The UE of claim 8, wherein the first power control value is associated with a target receive power level value or a fractional pathloss compensation coefficient.

10. The UE of claim 8, wherein:
the processor is further configured to select, based on a type of symbol on which the second UL channel or signal is to be transmitted, a second power control value from the second set of power control parameters,
the transceiver is further configured to transmit, based on the second power control value, the second UL channel or signal, and
the type of symbol is one of a downlink (DL) symbol, an UL symbol, or a flexible symbol.

11. The UE of claim 8, wherein:
the processor is further configured to select, based on a frequency-domain subband in a transmission bandwidth in which the second UL channel or signal is to be transmitted, a second power control value from the second set of power control parameters,
the transceiver is further configured to transmit, based on the second power control value, the second UL channel or signal, and
the frequency-domain subband is one of an UL subband, a flexible subband, or an UL bandwidth part (BWP).

12. The UE of claim 8, wherein:
the transceiver is further configured to receive an indication for a second power control value from the second set of power control parameters in a field of downlink control information (DCI);
the processor is further configured to determine, based on the indication and the second set of power control parameters, a transmission power for the second UL channel or signal, and
the transceiver is further configured to transmit the second UL channel or signal based on the transmission power.

13. The UE of claim 8, wherein the first power control value or a second power control value is associated with a configured grant physical uplink shared channel (PUSCH).

14. The UE of claim 8, wherein the first power control value or a second power control value is associated with a power of a demodulation reference signal (DMRS) resource element (RE) or a data RE corresponding to a physical uplink shared channel (PUSCH) transmission.

15. A base station (BS) comprising:
a transceiver configured to:
transmit first information for a first set of power control parameters for a first uplink (UL) channel or signal associated with a first subset of slots from a set of slots on a cell;
transmit second information for a second set of power control parameters for a second UL channel or signal associated with a second subset of slots from the set of slots on the cell; and
receive the second UL channel or signal in a slot from the second subset of slots, the second UL channel or signal associated with a first power control value from the second set of power control parameters,
wherein the first subset of slots does not include time-domain resources indicated for simultaneous transmission and reception on the cell, and
wherein the second subset of slots includes time-domain resources indicated for simultaneous transmission and reception on the cell.

16. The BS of claim 15, wherein the first power control value is associated with a target receive power level value or a fractional pathloss compensation coefficient.

17. The BS of claim 15, wherein:
the transceiver is further configured to receive the second UL channel or signal that is associated with a second power control value from the second set of power control parameters, the second power control value associated with a type of symbol on which the second UL channel or signal is received, and
the type of symbol is one of a downlink (DL) symbol, an UL symbol, or a flexible symbol.

18. The BS of claim 15, wherein:
the transceiver is further configured to receive the second UL channel or signal that is associated with a second power control value from the second set of power control parameters, the second power control value associated with a frequency-domain subband in a transmission bandwidth in which the second UL channel or signal is received, and
the frequency-domain subband is one of an UL subband, a flexible subband, or an UL bandwidth part (BWP).

19. The BS of claim 15, wherein the transceiver is further configured to:
transmit an indication for a second power control value from the second set of power control parameters in a field of downlink control information (DCI); and
receive the second UL channel or signal based on a transmission power associated with the indication and the second set of power control parameters.

20. The BS of claim 15, wherein the first power control value or a second power control value is associated with: (i) a configured grant physical uplink shared channel (PUSCH) or (ii) a power of a demodulation reference signal (DMRS) resource element (RE) or a data RE corresponding to a PUSCH transmission.
